(19) United States
(12) Patent Application Publication
(10) Pub. No.: US 2019/0301073 A1
(43) Pub. Date: Oct. 3, 2019

(54) CLEANING AGENT IDENTIFICATION

(71) Applicant: Henkel AG & Co. KGaA, Duesseldorf (DE)

(72) Inventors: Arnd Kessler, Monheim am Rhein (DE); Christian Nitsch, Duesseldorf (DE); Lars Zuechner, Langenfeld (DE); Georg Wawer, Wien (AT); Alexander Mueller, Monheim (DE)

(73) Assignee: Henkel AG & Co. KGaA, Duesseldorf (DE)

(21) Appl. No.: 16/318,006

(22) PCT Filed: Jul. 11, 2017
(86) PCT No.: PCT/EP2017/067334

§ 371 Date: Jan. 15, 2019

(30) Foreign Application Priority Data
Jul. 15, 2016 (DE) 10 2016 212 985.6

(51) Int. Cl. D06F 39/02; D06F 33/02; A47L 15/00; A47L 15/44; G05B 19/042

(52) U.S. Cl. CPC D06F 39/02; D06F 33/02; A47L 15/0055; A47L 15/449; G05B 2219/2633; D06F 2202/02; D06F 2202/12; D06F 2204/10; G05B 19/042

(57) ABSTRACT

The present disclosure relates to a method carried out by at least one device, the method comprising: acquiring (410) an identification characteristic of a cleaning agent (26), and checking (460), at least partially based upon the obtained identification characteristic of the cleaning agent (26), whether an initiation of a cleaning operation of a cleaning device (10) by the cleaning agent (26) is permissible. The present disclosure further relates to a device for carrying out the method, and to a corresponding computer program.

### CROSS-REFERENCE TO RELATED APPLICATION

This application is a U.S. National-Stage entry under 35 U.S.C. § 371 based on International Application No. PCT/EP2017/067334, filed Jul. 11, 2017 which was published under PCT Article 21(2) and which claims priority to German Application No. 10 2016 212 985.6, filed Jul. 15, 2016, which are all hereby incorporated in their entirety by reference.

### TECHNICAL FIELD

The present disclosure relates to methods and devices which can be used to identify a cleaning agent for a cleaning device or can make use of the identification.

### BACKGROUND

It is known, inter alia, from the prior art to improve a washing process by detecting the washing agent present in the washing cycle or in the washing phase, for example by adjusting the dose.

DE 10 2007 011 119 A1, for example, discloses a washing machine comprising automatic control of the washing process by using color-sensitive optical sensors for detecting control-relevant measured values. It is essential that the entire spectrum from infrared to ultraviolet is measured by employing an optical sensor device during the washing cycle, or parts of the spectrum that are characteristic for the task. By adding specific dyes that do not negatively influence the condition of the laundry, a specific color state can be associated with each washing agent by employing measurement. This makes it possible to identify the washing agent and e.g. to detect the type of washing agent, as well as the manufacturer thereof.

DE 42 04 806 A1 discloses a washing method for industrial laundries, various washing agents being dosed into the liquor in the same washing cycle, but at different washing stages. In order to determine the individual concentrations of a plurality of different washing agents when said agents are used in the same liquor, it is proposed to use washing agents or bleaching agents which, when irradiated with light, emit fluorescent radiation of different wavelength ranges in each case and to bring light to measuring points located in the liquor via optical fibers, absorb the light emitted there and add said light to a receiving and evaluating unit by employing the same or a second optical fiber, detect the intensities of the fluorescent radiation in one or more of the different wavelength ranges and detect the concentrations of the washing or bleaching agents used in the liquor by calibrating said washing or bleaching agents.

In addition, WO 2015/165733 A2 discloses a dosing system for the dosed supply of chemical substances stored in containers to a dishwasher or washing machine, which system comprises at least one dispensing device that can be connected to the container, a logic controller for controlling the operation of the at least one dispensing device and of the dishwasher or washing machine, and a user interface having a display and buttons for operating the logic system. The dosing system is modular. The logic controller is divided into a dispensing logic unit contained in a dispensing device and a machine logic unit that monitors and controls the dishwasher or washing machine.

Furthermore, a household appliance for cleaning objects, in particular a washing machine or dishwasher, is known from DE 100 39 408 B4, a device being provided for detecting at least one parameter of the washing or cleaning agent used. The parameter is the amount and/or the physical state, the type and/or an active ingredient of the washing or cleaning agent used. This can be used to improve dosing or to influence the program sequence in order to improve the washing result.

However, the proposed method and device still require improvement with regard to identifying a cleaning agent. In addition, there may be undesired washing agent uses or doses during the washing phase despite identification of a washing agent or of the dose of the washing agent.

In this context, the object of the present disclosure is to at least partially reduce or prevent the mentioned disadvantages from the prior art, i.e. in particular achieve user-friendly control for the user and/or to allow improved identification of a cleaning agent.

### BRIEF SUMMARY

Methods, apparatuses, and computer-readable storage media are provided herein that identify cleaning agents. In an embodiment, a method, which is carried out by at least one apparatus, includes obtaining, with the at least one apparatus, an identification characteristic of a cleaning agent. The method further includes checking, with the at least one apparatus and based at least in part on the obtained identification characteristic of the cleaning agent, whether it is permissible to initiate a cleaning process of a cleaning apparatus using the cleaning agent. The method further includes preventing initiating the cleaning process, with the at least one apparatus, using the cleaning agent after determining that it is not permissible to initiate the cleaning process of the cleaning apparatus using the cleaning agent. Alternatively or in addition to preventing initiation of the cleaning process, the method further includes initiating or allowing initiation of the cleaning process, with the at least one apparatus, using the cleaning agent after determining that it is permissible to initiate the cleaning process of the cleaning apparatus using the cleaning agent.

### BRIEF DESCRIPTION OF THE DRAWINGS

The present disclosure will hereinafter be described in conjunction with the following drawing figures, wherein like numerals denote like elements, and wherein:

FIG. 1 is a schematic view of an embodiment of a system as contemplated herein;

FIG. 2a is a schematic view of an embodiment of a cleaning device;

FIG. 2b is a schematic view of an embodiment of a dispensing compartment;

FIG. 2c is a schematic view of an embodiment of a dosing aid;

FIG. 3 is a block diagram of an embodiment of a device as contemplated herein;

FIG. 4 is a block diagram of an embodiment of a method as contemplated herein; and

FIG. 5 shows different embodiments of a memory medium.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

According to a first aspect of the present disclosure, a method is described which is carried out by at least one device, the method comprising: obtaining an identification characteristic of a cleaning agent, and checking, based at least in part on the obtained identification characteristic of the cleaning agent, whether it is permissible to initiate a cleaning process of a cleaning apparatus using the cleaning agent.

The apparatus for carrying out the method according to the first aspect may, for example, be an apparatus according to the first aspect. For example, the apparatus is the cleaning apparatus or a data processing system, for example a mobile device or a server.

A cleaning apparatus can be a washing machine or a dishwasher, for example. The cleaning apparatus is in particular a (automatic) household cleaning appliance, for example a household washing machine.

The washing machine may have various different designs. There is a distinction between top-loading washing machines, in which the loading opening is on the top, and front-loading washing machines, in which a porthole on the front serves as the loading opening. An advantage of top-loading washing machines is that it is easier to construct the door seal and the drum can be supported on two sides by roller bearings; a top-loading washing machine can also be positioned in very small spaces where there is not enough space to open a front door. By contrast, a front-loading washing machine provides space on top for e.g. a tumble dryer or for a worktop, and is therefore sometimes built into a kitchen unit instead of a floor unit. Top-loading washing machines are disadvantageous since they require a greater volume of water for washing laundry than front-loading washing machines.

American top-loading washing machines always have a rotating drum and mixing elements (agitators or discs), with the mixing elements being able to move in or counter to the rotational direction of the drum. The machines may comprise a suds circulator and injectors for the suds. In principle, there is a distinction between deep-fill and HE top-loading washing machines. Deep-fill top-loading washing machines operate at specified water levels, and therefore do not use any load detection. HE washing machines generally have load detection and control the quantities of water in accordance therewith. Generally, the machines do not have an integrated heater, but instead are connected to a hot water feed.

A cleaning agent may be a washing agent or a dishwasher detergent, for example. However, a cleaning agent may be not only the agent that causes actual cleaning, but also a cleaning agent aid or cleaning additive, such as a bleaching additive, a fabric softener, or starch. A cleaning agent may be a liquid, a disperse system, for example a gel or foam, or a solid, in particular a tablet, powder or granulate.

A cleaning agent may, for example, comprise one or more components from the group of components including surfactants, alkalis, builders, optical brighteners, enzymes, bleaching agents, soil-release polymers, fillers, plasticizers, fragrances, dyes, care substances, acids, starch, isomalt, sugar, cellulose, cellulose derivatives, carboxymethylcellulose, polyetherimide, silicone derivatives, and/or polymethylimines.

A cleaning agent may also comprise one or more other components. These components include, but are not restricted to, the group of bleach activators, complexing agents, builders, electrolytes, non-aqueous solvents, pH adjustments, scent carriers, fluorescing agents, hydrotropic substances, silicone oils, bentonites, anti-redeposition agents, shrinkage-preventing agents, crease-preventing agents, dye transfer inhibitors, fillers, antimicrobial active ingredients, germicides, fungicides, antioxidants, preservatives, corrosion inhibitors, antistatic agents, bittering agents, ironing aids, repellents and impregnating agents, anti-swelling and anti-slip agents, and UV absorbers.

A cleaning process may comprise, for example, an automatic, in particular at least partially predefined, sequence of cleaning steps or cleaning cycles. In particular in the case of a washing process, a cleaning process may comprise, for example, one or more main cleaning cycles, one or more rinsing cycles and/or one or more spin cycles. The cleaning agent is used for a main cleaning cycle, for example, in the case of a main washing agent and for a rinsing cycle in the case of a fabric softener.

Initiating a cleaning process is understood in particular to mean starting or beginning a cleaning process. Initiation of a cleaning process can be triggered, for example, automatically or manually by a user (for example by employing of a user interface, such as a user interface of the cleaning device).

An identification characteristic of a cleaning agent is understood to mean a piece of information (or data representing this piece of information) which is characteristic for the cleaning agent or a group of cleaning agents. This can make it possible to identify the cleaning agent by employing the identification characteristic, or to identify a group of cleaning agents that is to be associated with the cleaning agent, and/or to distinguish said agent or group from other cleaning agents or from another group of cleaning agents. An identification characteristic may comprise at least one characteristic (or a plurality of characteristics). In this respect, a characteristic (or feature) can be considered in particular to be representative of a detectable property of the cleaning agent that distinguishes the cleaning agent from other cleaning agents. An identification characteristic can be considered in particular to be a fingerprint of the cleaning agent.

By checking whether it is permissible to initiate the cleaning process of a cleaning apparatus using the cleaning agent, initiating a cleaning process can be influenced as required. For example, this can prevent (e.g. unintended) use of the cleaning apparatus using non-permissible cleaning agents. Using permissible cleaning agents is also permitted. A cleaning agent is considered permissible, for example, if the cleaning agent is desired or suitable for a cleaning process using the cleaning agent. Because checking does not take place, for example, only during the washing process, i.e. for example during a washing cycle, but rather checking whether it is permissible to initiate a cleaning process takes place already, the user-friendliness of operating the cleaning apparatus can be improved. In addition, the quality of the cleaning process can be improved, for example, or the service life of the cleaning apparatus can be increased, as only cleaning agents that are considered to be permissible are used, for example.

Checking being based at least in part on the obtained identification characteristic is, for example, understood to mean that the obtained identification characteristic is used to check the permissibility of initiating a cleaning process. Further information can also be used for this purpose.

According to an embodiment of the method according to the first aspect, the method further comprises preventing initiation of the cleaning process using the cleaning agent if the check indicates that it is not permissible to initiate the cleaning process of the cleaning apparatus using the cleaning agent, and/or initiating or allowing initiation of the cleaning process using the cleaning agent if the check indicates that it is permissible to initiate the cleaning process of the cleaning apparatus using the cleaning agent.

Initiation of a cleaning process using the cleaning agent can be prevented, for example, by automatic or manual initiation of the cleaning process not being possible and/or being ignored. For example, initiation of a cleaning process is prevented at least temporarily. A cleaning process using the cleaning agent can be initiated or allowed to be initiated, for example, by automatic or manual initiation of the cleaning process taking place or being activated.

For example, the check indicates that it is not permissible to initiate a cleaning process of a cleaning apparatus using the cleaning agent if it is not established, or cannot be established, that the obtained identification characteristic of the cleaning agent satisfies a predetermined condition (for example, corresponds to a specific identification characteristic). For example, the check indicates that it is permissible to initiate a cleaning process of a cleaning apparatus using the cleaning agent if it is established that the obtained identification characteristic of the cleaning agent satisfies a predetermined condition (for example, corresponds to a specific identification characteristic).

If the cleaning process is initiated or initiation is allowed, this can be considered in this respect to be a (successful) “handshake” between the cleaning agent and the cleaning apparatus before the actual cleaning process begins.

If the checking step shows that it is permissible to initiate the cleaning process of the cleaning apparatus using the cleaning agent, this information can be used, for example, to grant the user a discount or credit voucher. For example, a piece of information, representative of the use of a permissible cleaning agent by the user, is sent to a server, so that the user can be granted a corresponding discount or credit voucher. For this purpose, the user can have a user account, for example. The user account can, for example, log the use of permissible cleaning agents. The discount can be a points discount, for example, in which bonus points that have been accumulated pro rata by previous uses of the permissible cleaning agent can be used for price reductions on future purchases or for rewards.

According to an embodiment of the method according to the first aspect, the method further comprises comparing the obtained identification characteristic of the cleaning agent with at least one reference characteristic.

The result of the comparison can be used for checking whether it is permissible to initiate the cleaning process of the cleaning apparatus using the cleaning agent. If it is established, for example, that the obtained identification characteristic and at least one reference characteristic are identical or (sufficiently) similar, it can be deduced that it is permissible or not permissible to initiate a cleaning process of the cleaning apparatus.

With regard to a reference characteristic, reference is made to the embodiments of the identification characteristic. Correspondingly, a reference characteristic can be understood to mean a piece of information (or data representing said piece of information) which is characteristic for a reference cleaning agent or a group of reference cleaning agents.

Various comparison methods are used to compare the identification characteristic with one or more reference characteristics. For example, comparison can be carried out by employing a similarity analysis, for example based on one or more artificial neural networks. Another example is the use of a support vector machine (SVM). A support vector machine divides an amount of objects into classes such that the widest possible range around the class boundaries remains free of objects. In this way, cleaning agents or relevant identification characteristics or reference characteristics are divided into classes or groups. The identification characteristic and/or the reference characteristic can therefore be a vector or support vector. In this way, the obtained information characteristic can be compared with one or more reference characteristics and the cleaning agent can thus be identified or allocated to a group.

According to an embodiment of the method according to the first aspect, the method comprises obtaining (and/or detecting) identification characteristics of cleaning agents multiple times. The identification characteristics can be used, for example, to create a user profile. In a user profile of this kind, the identification characteristics or information derived therefrom can be associated with additional information (for example with the number and/or the age of each individual in a household in order to create a personalized user profile, or for example with the seasons to create a seasonal user profile). Evidence regarding future behavior (for example of the expected cleaning agent use) of the user can be derived from a profile of this kind.

The identification characteristics can be used in particular for machine learning. The reference characteristic can therefore be determined based at least in part on machine learning. The described steps of checking and/or comparing can likewise draw on machine-learned information. Machine learning is understood to mean that an artificial system (for example an apparatus according to the first aspect or a system according to the first aspect) learns from examples and can generalize said examples after the learning phase has ended. This mean that it does not simply learn the examples by heart, but that patterns and regularities are recognized in the learning data. Various approaches can be taken for this purpose. For example, supervised learning, semi-supervised learning, unsupervised learning, reinforcement learning and/or active learning can be used. Monitored learning can take place by employing an artificial neural network (for example a recurrent neural network) or by employing a support vector machine, for example. Unmonitored learning can also take place by employing an artificial neural network (for example an autoencoder), for example. The identification characteristics obtained and/or detected multiple times can be used as learning data, for example.

As a result of these measures, the reliability of a check or comparison can be increased or further evidence can be derived from the obtained information.

According to an embodiment of the method according to the first aspect, the method further comprises detecting the identification characteristic of the cleaning agent. Detection is carried out by a sensor, for example.

For example, the sensor for detecting the identification characteristic of the cleaning agent comprises at least one optical sensor. For example, the optical sensor comprises at least one photodiode and optionally one light-emitting diode. For example, the optical sensor comprises a spectrometer (for example a UV/Vis spectrometer). For example, the optical sensor is configured to detect absorption or emission of the cleaning agent (for example of an absorption and/or emission spectrum). For example, the optical sensor is configured to detect visible or invisible electromagnetic radiation. For example, the optical sensor is configured to detect UV radiation, for example UVA, UVB or UVC radiation. For example, the sensor is configured to detect infrared radiation, for example NIR, MIR or FIR radiation.

For example, the sensor comprises a hyperspectral sensor, for example a hyperspectral camera. Hyperspectral images can be thus obtained. In this case, intensity distribution of the image has intensity values in a plurality of channels for different energy intervals, at least two of the energy intervals being interconnected or overlapping one another. In particular, a hyperspectral image can be distinguished from a multispectral image in that a multispectral image also has intensity values in a plurality of channels for different energy intervals, the energy intervals being spaced apart, however, i.e. in a multispectral image, the intensities of individual energies separated from one another are reproduced. By contrast, in a hyperspectral image, in particular “adjacent” intensity values are reproduced, in that at least two of the energy intervals are interconnected or overlap one another. A hyperspectral image can therefore depict a continuous spectrum at least in part. An intensity distribution that is representative of a hyperspectral image has in particular the advantage that information not visible to the naked eye which can contribute to the identification characteristic can be recorded.

For example, the sensor for detecting the identification characteristic of the cleaning agent comprises at least one sound sensor, for example an ultrasound sensor.

For example, the sensor comprises at least one conductivity sensor. A conductivity sensor can be used to measure the electrical conductivity of the cleaning agent. A conductivity sensor comprises two (or more) electrodes, for example. These electrodes are preferably arranged such that they come into contact with the cleaning agent during conventional use of a cleaning agent.

For example, the sensor for detecting the identification characteristic of the cleaning agent comprises at least one gas sensor, for example an electrochemical sensor. For example, the gas sensor is configured to detect odorants or odorant compositions. For example, the detected identification characteristic is based on the intensity, temporal sequence, rising behavior and/or decay behavior of a sensor signal. As a gas sensor can often detect only one or a few ingredients, it is advantageous to provide more than one gas sensor, for example a sensor array of different gas sensors.

For example, the sensor comprises a combination of different sensors (for example an optical sensor and a conductivity sensor).

For example, the sensor comprises at least one soft sensor or virtual sensor. A soft sensor is understood to mean not a sensor that exists in reality, but rather a dependency simulation of representative measured values to a target value. The target value is therefore not directly measured, but rather is calculated based on measured values correlating therewith and a model of the correlation.

The described embodiment is intended to be disclosed independently of the method according to the first aspect. A method is therefore disclosed according to a further aspect which is carried out by at least one apparatus, the method comprising: detecting an identification characteristic of a cleaning agent. Detection can, as described, be carried out by employing the described sensor. In this case, the method according to this aspect can, however, be designed further according to the described embodiments of the first aspect.

According to an embodiment of the method according to the first aspect, the identification characteristic is detected by at least one sensor of a cleaning apparatus or part thereof or a dosing aid.

For example, the sensor or part thereof is or can be integrated in the cleaning apparatus. For example, the sensor or part thereof is installed in the cleaning apparatus. For example, the sensor or part thereof is integrated in a dispensing chamber, a storage chamber and/or a (automatic) dosing system of the cleaning apparatus.

For example, the sensor is integrated in a dosing aid. The dosing aid is used to dose the cleaning agent. For example, the dosing aid is designed as a measuring apparatus (for example as a measuring vessel).

According to an embodiment of the method according to the first aspect, the method further comprises obtaining the reference characteristic. For example, the reference characteristic can be received and/or stored by the apparatus that carries out the method according to the first aspect, i.e. the cleaning apparatus or a data processing system (for example a mobile device), for example. For example, the data is transmitted by a server.

According to an embodiment of the method according to the first aspect, the identification characteristic allows identification of the cleaning agent and/or of a cleaning agent group.

Identification of the cleaning agent is understood to mean that a cleaning agent can be identified as a product of identical products, for example. For example, the obtained identification characteristic allows unique identification of the cleaning agent.

Identification of the cleaning agent group is understood in particular to mean that a cleaning agent group can be identified to which a cleaning agent can be allocated. For example, cleaning agents of a manufacturer form a cleaning agent group, such that the cleaning agent can be associated with a cleaning agent manufacturer by employing the identification characteristic. This is advantageous if the cleaning apparatus is intended to be used only using cleaning agents of a manufacturer, for example. For example, cleaning agents form a kind of cleaning agent group, such that the cleaning agent can be associated with a cleaning agent type (e.g. laundry detergent, color-safe detergent, bleaching agent, fabric softener etc.) by employing the identification characteristic. For example, for an intended use, cleaning agents form a cleaning agent group, such that a cleaning agent can be associated with a cleaning agent use by employing the identification characteristic (e.g. washing textiles, washing colored laundry, bleaching, fabric softening etc.).

According to an embodiment of the method according to the first aspect, the identification characteristic is representative of at least one chemical and/or physical property of the cleaning agent.

A physical property of the cleaning agent may be, for example, a spectral property (e.g. a color, an absorption spectrum and/or emission spectrum), density, heat conductivity, electrical conductivity, magnetic permeability or remanence, a physical state (solid, liquid, gaseous) at a specific temperature, an optical activity, viscosity, surface tension, heat capacity and/or sound velocity.

A chemical property may be, for example, an odor, reactivity to various other substances, a pH, an acid dissociation constant and/or a base dissociation constant.

In order to detect a physical and/or chemical property of the cleaning agent, a corresponding sensor for detecting the corresponding physical and/or chemical property can be provided.

In order to improve identification, the identification characteristic can be, for example, at least representative of a first and a second property of the cleaning agent.

According to an embodiment of the method according to the first aspect, the identification characteristic is representative of a spectral property and/or electrical conductivity of the cleaning agent. It has been proven that a spectral property and electrical conductivity in cleaning agents can be detected rapidly, precisely and robustly, which allows reliable identification of the cleaning agent or of a cleaning agent group.

According to an embodiment of the method according to the first aspect, the cleaning agent contains one or more additives for inducing the identification characteristic.

An additive is understood to mean an ingredient of the cleaning agent which is not necessary for the actual function of the cleaning agent and/or does not affect or only negligibly affects the actual function. In particular, the additive is not necessary for manufacturing, storing, processing or ensuring the effectiveness of the cleaning agent.

However, the additive makes it possible in particular to set a specific identification characteristic, such that in particular it is possible to identify the cleaning agent or the cleaning agent group. However, it is possible that the additive simultaneously has an advantageous or desired effect with regard to manufacturing, storing, processing or effectiveness.

The described embodiment is intended to be disclosed independently of the method according to the first aspect. A method is therefore disclosed according to a further aspect which is carried out by at least one apparatus, the method comprising: obtaining an identification characteristic of a cleaning agent, the cleaning agent containing one or more additives for inducing the identification characteristic. The additive(s) can be provided as described. In this case, the method according to this aspect can, however, be designed further according to the described embodiments of the first aspect.

According to an embodiment of the method according to the first aspect, the one or more additives comprise: a chemical marker, a dye, a functional dye, an odorant, and/or a substance that modifies the conductivity.

A chemical marker is understood to mean an additive which makes it possible to identify the cleaning agent particularly uniquely. A chemical marker may be, for example, a dye, a substance for producing a specific absorption property (in particular an absorption band) or a substance for producing a specific emission (e.g. fluorescence). In this case, the absorption and/or emission can be in the visible or invisible part of the electromagnetic spectrum, for example.

A chemical marker may be, for example, a filter dye, a light protection filter, in particular a UV protection filter, for example octinoxate ((E,RS)-4-methoxycinnamic acid-2-ethylhexylester).

A functional dye is understood to be a substance which fulfils a specific function when used, but which does not involve aesthetic coloring. This means that the color thereof is typically irrelevant for use, or it is used for a purpose that does not need to have anything to do with making a substrate more optically attractive. Examples of functional dyes are, for example, dyes which absorb light at a specific wavelength and convert the absorbed light into heat, re-emit the light at another wavelength (for example as a phosphorescent marker), modify the polarization direction of the light, produce electrical phenomena or permit photochemical processes.

Examples of functional dyes are chemical dyes registered under the following CAS (Chemical Abstracts Service) names: 536-17-4, 28172-08-9, 6813-38-3, 54389-98-9, 121482-73-3, 76433-27-7, 905-96-4, 70024-44-1, 25152-49-2, 137147-59-2, 131443-20-4, 189189-12-6, 206439-63-6, 4182-80-3, 155795-24-7, 62669-60-7, 215370-93-7, 326801-92-7, 599177-24-9, 28705-46-6, 94856-25-4, 663161-10-2, 207399-07-3, 777816-94-1, 28984-20-5, 38951-97-2, 143193-48-0, 92050-35-6, 27969-56-8, 19381-50-1, 101708-53-6, 50663-19-9, 63148-97-0, 41503-61-1, 77837-26-4, 143269-53-8, 117898-57-4, 103534-62-9, 77418-33-8, 977-96-8, 52525-52-7, 2602-17-7, 51257-37-5, 143269-69-6, 34330-15-9, 2445-60-5, 144940-73-8, 35501-76-9, 32634-36-9, 52525-55-0, 28784-39-6, 23216-67-3, 67326-80-1, 60760-42-1, 33628-03-4, 105176-22-5, 35795-44-9, 52749-17-4, 203785-75-5, 63811-40-5, 152340-26-6, 88358-74-1, 7696-70-0, 5496-71-9, 113869-06-0, 27425-55-4, 90-33-5, 91-44-1, 41267-76-9, 55804-66-5, 38465-55-3, 7385-67-3, 89846-21-9, 13558-31-1, 62669-66-3, 989-38-8, 24796-94-9, 87-01-4, 50378-83-1, 17636-08-7, 28118-05-0, 143174-04-3, 91101-24-5, 51858-17-4, 143269-64-1, 86213-20-9, 143269-62-9, 117133-81-0, 63524-66-3, 24139-57-9, 131512-74-8, 20328-87-4, 93857-83-1, 61105-57-5, 101-75-7, 6935-44-0, 3695-85-0, 115324-57-7, 253267-46-8, 253267-38-8, 1064-48-8, 99610-72-7, 112078-08-7, 123174-58-3, 331861-93-9, 1510824-40-4, 494762-23-1,68239-70-3, 177168-18-2 and 147613-95-4.

An odorant may be, for example, a natural or synthetic odorant.

A substance that influences the conductivity is understood in particular to mean a substance that deliberately influences the conductivity. For example, a salt can be a substance that modifies the conductivity.

According to an embodiment of the method according to the first aspect, the method further comprises: initiating or allowing initiation of the cleaning process using the cleaning agent after initiation of the cleaning process using the cleaning agent has been prevented.

For example, initiation of the cleaning process using the cleaning agent is initially prevented because the check has indicated that it is not permissible to initiate the cleaning process using the cleaning agent. However, in order to give the user the option of initiating a cleaning process or a cleaning process not provided for the cleaning agent, even using an undesired cleaning agent, for example in an emergency, initiation or allowing initiation of the cleaning process using the cleaning agent subsequently takes place nonetheless. This can be considered to be an override function.

According to an embodiment of the method according to the first aspect, the method further comprises checking the compatibility of the cleaning agent with the cleaning process to be initiated or at least one parameter thereof, based at least in part on the obtained identification characteristic.

A parameter of the cleaning process to be initiated is, for example, temperature (e.g. 30° C., 60° C. or 90° C. in the case of a washing machine) and/or the cleaning program (e.g. easy care, hot/colored wash, delicates etc. in the case of a washing machine). The cleaning agent or the cleaning agent group to which the cleaning agent is allocated can be identified by employing the obtained identification characteristic. For example, additional information associated with the identified cleaning agent or the identified cleaning agent group (e.g. compatibility information, which is representative of the cleaning processes or parameters thereof that are compatible with the cleaning agent) can be obtained.

Checking whether it is permissible to initiate the cleaning process using the cleaning agent can be based on checking the compatibility. If compatibility is established, it can be concluded that it is permissible to initiate the cleaning process of the cleaning apparatus using the cleaning agent. However, if incompatibility is established, it can be concluded that it is not permissible to initiate the cleaning process of the cleaning apparatus using the cleaning agent. In this case, too, checking is based at least in part on the obtained identification characteristic of the cleaning agent.

According to an embodiment of the method according to the first aspect, the method further comprises checking and/or influencing the cleaning process of the cleaning apparatus using the cleaning agent, based at least in part on the obtained identification characteristic of the cleaning agent.

For example, influencing a cleaning process can comprise influencing the temperature (e.g. about 30° C., about 60° C., about 90° C. in the case of a washing machine) and/or the cleaning program (e.g. easy care, hot/colored wash, delicates etc. in the case of a washing machine). As another example, influencing a cleaning process can comprise influencing the amount of water used.

According to an embodiment of the method according to the first aspect, the method further comprises checking and/or influencing a dosage of the cleaning agent, based at least in part on the obtained identification characteristic of the cleaning agent.

For example, the dosage is automatically adapted in the case of automatic dosing integrated in the cleaning apparatus. In the case of manual dosing, a dosage recommendation can be output or an output of said recommendation can be triggered for example by the cleaning apparatus and/or a data processing system (e.g. a mobile device of the user). For this purpose, a dosing aid having a sensor can be provided, for example, which detects the amount of cleaning agent located therein. The amount located therein can then be checked. As already explained, the cleaning agent or the cleaning agent group to which the cleaning agent is to be allocated can be identified by employing the obtained identification characteristic, such that for example a piece of dosing information (e.g. representing a dosing matrix) for the cleaning agent can be obtained. The piece of dosing information can comprise a piece of information regarding a commended dosage of the cleaning agent depending on water hardness, an amount of objects to be cleaned (e.g. an amount of water) and/or soiling.

The amount of objects to be cleaned can be detected by a sensor of the cleaning apparatus, for example. Checking and/or influencing a dosage of the cleaning agent can be based on the amount of objects to be cleaned.

For example, it is also conceivable that a piece of position information is obtained which is representative of the position of the user or of the cleaning apparatus. Information regarding the water hardness at this position, for example, can be thus obtained. Checking and/or influence a dosage of the cleaning agent can therefore be based on the information regarding the water hardness.

According to the first aspect, an apparatus is described that is designed or comprises corresponding features for carrying out and/or controlling a method according to the first aspect.

According to the first aspect, an apparatus is described that comprises at least one processor and at least one memory comprising computer program code, the at least one memory and the computer program code being designed to carry out and/or control at least one method according to the first aspect using the at least one processor. A processor is intended to be understood to be, for example, a control unit, a microprocessor, a microcontrol unit such as a microcontroller, a digital signal processor (DSP), an application-specific integrated circuit (ASIC) or a field programmable gate array (FPGA).

For example, an exemplary apparatus further comprises features for storing information, such a program memory and/or a main memory. For example, an exemplary apparatus as contemplated herein further comprises respective features for receiving and/or transmitting information over a network, such as a network interface. For example, exemplary apparatuses as contemplated herein are and/or can be interconnected via one or more networks.

An exemplary apparatus according to the first aspect is or comprises, for example, a data-processing system configured using software and/or hardware in order to be able to execute the respective steps of an exemplary method according to the first aspect. The data processing system may be the cleaning apparatus or a part thereof, for example. Further examples of a data processing system are a computer, a desktop computer, a server, a thin client and/or a portable computer (mobile device), such as a laptop computer, a tablet computer, a wearable, a personal digital assistant or a smartphone.

This means, for example, that all or individual method steps that do not necessarily need to be carried out by the cleaning apparatus, for example, are executed by an additional apparatus, which may be connected to the cleaning apparatus via a communication system, for example. An apparatus of this kind may be, for example, a server and, for example, a part or a component of a “computer cloud,” which provides data processing resources dynamically for different users in a communication system. A computer cloud is in particular understood to mean a data processing infrastructure in accordance with the definition from the National Institute for Standards and Technology (NIST) for the term “cloud computing.” One example of a computer cloud is a Microsoft Windows Azure platform.

According to the first aspect, a computer program is also described that comprises program instructions that prompt a processor to execute and/or control a method according to the first aspect when the computer program runs on the processor. An exemplary program as contemplated herein may be stored in or on a computer-readable memory medium which contains one or more programs.

According to the first aspect, a computer-readable storage medium containing a computer program according to the first aspect is also described. A computer-readable memory medium may be designed e.g. as a magnetic, electrical, electromagnetic, optical and/or different memory medium. A computer-readable memory medium of this type is preferably a physical object (i.e. “tangible”); for example it is designed as a data carrier device. A data carrier device is, for example, portable or permanently installed in a device. Examples of a data carrier device of this type are volatile or non-volatile memories with random access (RAM), such as NOR flash memories, or with sequential access, such as NAND flash memories, and/or memories with read-only access (ROM) or read/write access. Computer-readable is, for example, intended to be understood to mean that the memory medium can be read and/or written by a computer or a data processing system, for example by a processor.

According to the first aspect, a system is also described that comprises a plurality of apparatuses, in particular comprising an apparatus according to the first aspect, which together are configured to carry out a method according to the first aspect.

An exemplary system according to the first aspect comprises an exemplary apparatus according to the first aspect, for example a cleaning apparatus and/or a dosing aid, and additionally a data processing system, for example a mobile device or a server. The exemplary embodiments of the present disclosure described above in this description are also intended to be understood to be disclosed in any combination with one another. In particular, exemplary embodiments are intended to be understood to be disclosed in relation to different aspects.

In particular, by way of the preceding or following description of method steps according to preferred embodiments of a method, corresponding features for carrying out the method steps are also intended to be disclosed by preferred embodiments of an apparatus. Likewise, the disclosure of features of an apparatus for carrying out a method step is also intended to disclose the corresponding method step.

Further advantageous, exemplary embodiments of the present disclosure are found in the following detailed description of some exemplary embodiments of the present disclosure, in particular in conjunction with the drawings. However, the drawings are provided only for illustrative purposes, and do not serve to define the scope of protection of the present disclosure. The drawings are not to scale and are intended merely to provide an example of the general concept of the present disclosure. In particular, features contained in the drawings are not in any way intended to be considered as necessary components of the present disclosure.

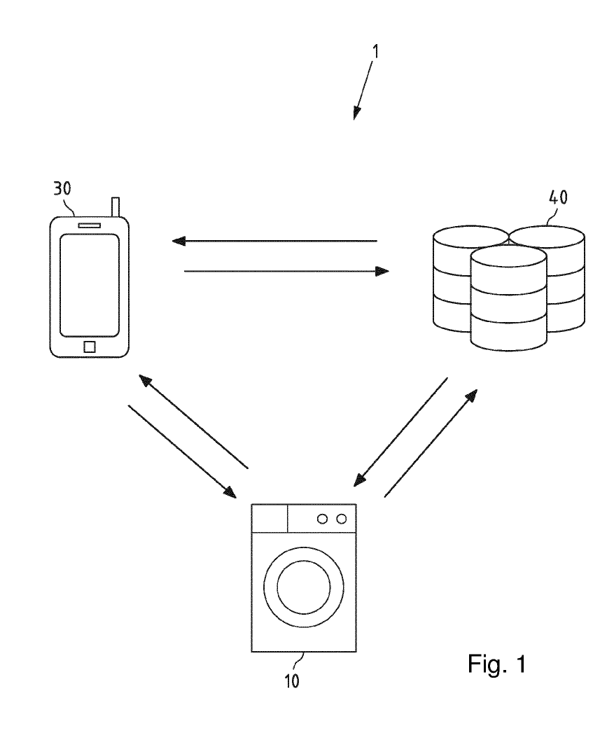

FIG. 1 first shows an exemplary system 1 according to the first aspect, comprising exemplary apparatuses 10, 30, 40, each of which may be an apparatus according to the first aspect.

The system 1 comprises a cleaning apparatus 10 shown by way of example. Furthermore, the system 1 comprises a mobile device 30 in the form of a smartphone. Finally, the system 1 comprises a server 40, which may be in particular remote from the cleaning apparatus 10 and the mobile device 30. However, the system 1 may comprise only two or more than three apparatuses.

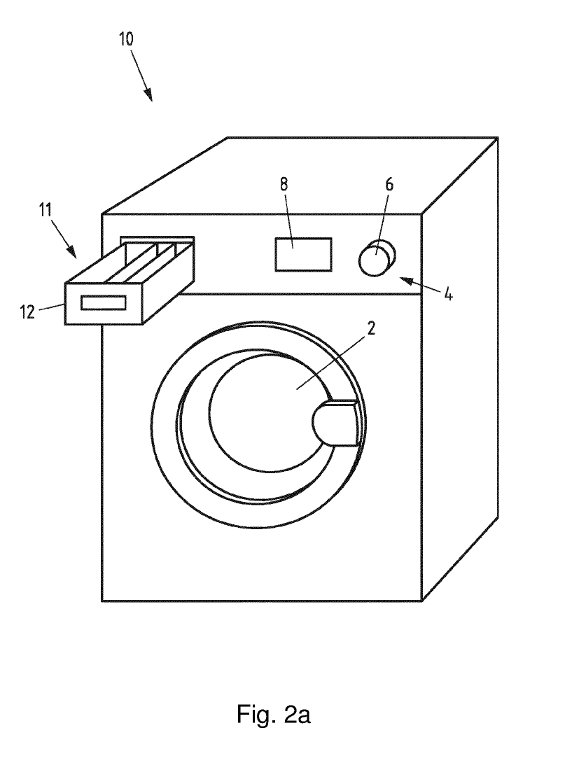

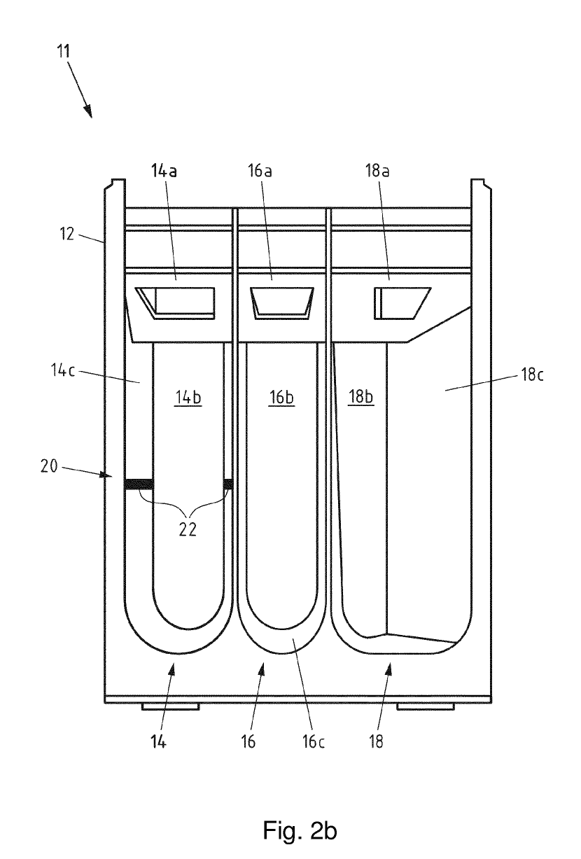

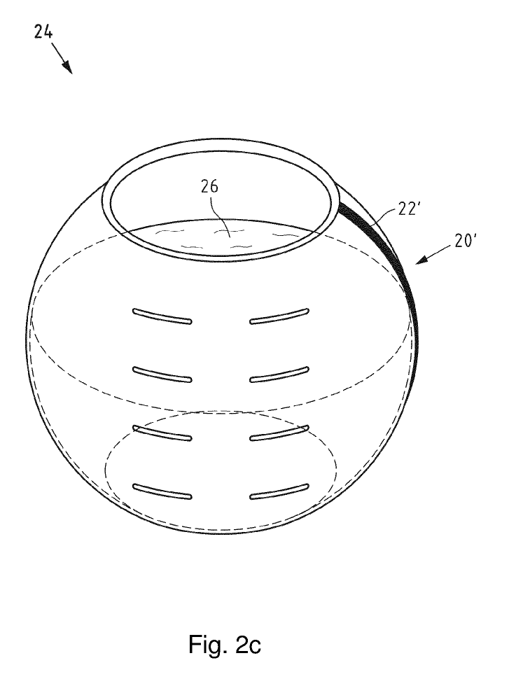

The cleaning apparatus 10 may comprise a sensor 20 (see FIG. 2b), which is configured to detect an identification characteristic of a cleaning agent introduced into the cleaning apparatus 10.

In addition, the cleaning apparatus 10 may comprise a communication interface, in order to communicate with the server 40 and/or the mobile device 30. Correspondingly, the mobile device 30 may comprise a communication interface in order to exchange information with the cleaning apparatus 10 and/or the server 40.

FIG. 2a shows the cleaning apparatus 10 from FIG. 1. The cleaning apparatus 10 may be an embodiment of an apparatus of the first aspect and in particular can carry out embodiments of the method according to the first aspect or parts thereof. In this case, the cleaning device 10 is an automatic household washing machine for textiles, which is designed as a drum-type washing machine in which a washing drum 2 rotates about a horizontal axis (front-loading washing machine). However, it is also conceivable to use other types of cleaning apparatus. The washing machine 10 comprises, in addition to the drum 2, user interfaces 4 in the form of a control element 6 and a display element 8. The control element 6 is designed as a rotary knob and can be used to set various washing parameters, for example of the washing program and the washing temperature. The display element 8 can optically display information to the user. However, the washing machine 10 may also comprise additional user interfaces. The washing machine 10 further comprises a dispensing 11, which comprises a detergent drawer 12.

FIG. 2b is an enlarged view of the detergent drawer 12. In this case, the detergent drawer 12 comprises three compartments 14, 16, 18, which are each designed for receiving a cleaning agent (for example cleaning agent 26 from FIG. 2c). The compartments 14, 16, 18 are, for example, a compartment for receiving a washing agent for a pre-wash cycle, a compartment for receiving a washing agent for the main wash cycle, and a compartment for receiving a fabric softener. Each compartment 14, 16, 18 comprises a flow barrier 14a, 16a, 18a. The compartments each comprise a bottom 14b, 16b, 18b and side walls 14c, 16c, 18c.

The compartment 14 of the detergent drawer 12 further comprises a sensor 20 having a sensor 22, which, in this example, is designed as a conductivity sensor having two electrodes along the side wall 14c of the compartment 14. The sensor 20 or in any case part thereof is integrated in the dispensing 11 and therefore in the cleaning apparatus 10. The sensor 20 is configured to detect an identification characteristic, in this case representing the conductivity of the cleaning agent. However, the sensor 20 may alternatively or additionally comprise sensors for detecting an identification characteristic representing other physical or chemical properties of the cleaning agent. In this respect, one or more other sensors, such as an optical sensor, a sound sensor and/or a gas sensor, can alternatively or additionally be provided.

It is likewise possible to provide the sensor 20 for detecting an identification characteristic in a storage chamber (for example a cartridge that can be inserted into the cleaning apparatus 10) or a (automatic) dosing system.

A sensor integrated in the cleaning apparatus 10 may, for example, be connected to a bus line of the cleaning appliance 10 or communicate wirelessly with the cleaning apparatus 10.

A sensor for detecting the identification characteristic can likewise be provided outside the cleaning apparatus, for example in a dosing aid. To this end, FIG. 2c is a schematic view of an embodiment of a dosing aid 24. The dosing aid is designed as a measuring container made of plastics material and is filled in part with a cleaning agent 26. The dosing aid comprises a sensor 20′ having a sensor 22′ for detecting an identification characteristic. The sensor 22′ may, as described above, be a conductivity sensor. However, one or more sensors can also be used.

In this case, the sensor 20′ can communicate wirelessly with the cleaning apparatus 10 and/or the mobile device 30 and in particular transmit a detected identification characteristic of the cleaning agent.

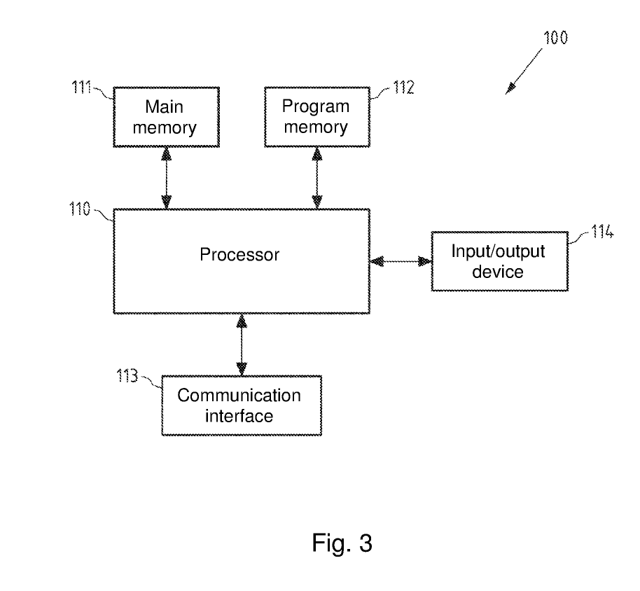

FIG. 3 is a block diagram of an embodiment of an apparatus 100, which in particular can carry out an exemplary method according to the first aspect. The apparatus 100 is, for example, an apparatus according to the first aspect, for example the cleaning apparatus 10, the mobile device 30 or the server 40. However, individual or all the illustrated components can likewise be implemented in the dispensing 10 or into the dosing 24, for example.

In this respect, the apparatus 100 may for example be a computer, a desktop computer, a server, a thin client or a portable computer (mobile device), such as a laptop computer, a tablet computer, a wearable, a personal digital assistant (PDA) or a smartphone. The apparatus may perform the function of a server or a client, for example.

The processor 110 of the device 100 is in particular designed as a microprocessor, a microcontrol unit, a microcontroller, a digital signal processor (DSP), an application-specific integrated circuit (ASIC) or a field programmable gate array (FPGA).

The processor 110 executes program instructions that are stored in the program memory 112, and for example stores intermediate results or the like in a working memory or main memory 111. For example, the program memory 112 is a non-volatile memory such as a flash memory, a magnetic memory, an EEPROM memory (electrically erasable, programmable read-only memory), and/or an optical memory. The main memory 111 is, for example, a volatile or non-volatile memory, in particular a memory with random access (RAM) such as a static RAM memory (SRAM), a dynamic RAM memory (DRAM), a ferroelectric RAM memory (FeRAM), and/or a magnetic RAM memory (MRAM).

The program memory 112 is preferably a local data carrier that is permanently connected to the apparatus 100. Data carriers that are permanently connected to the apparatus 100 are hard drives that are integrated in the apparatus 100, for example. Alternatively, the data carrier may, for example, also be a data carrier that can be detachably connected to the apparatus 100, such as a memory stick, a removable storage device, a portable hard drive, a CD, a DVD, and/or a floppy disk.

The program memory 112 contains, for example, the operating system of the apparatus 100, which is loaded in the main memory 111 at least in part and is executed by the processor 110 when the device 100 is started up. In particular, when starting up the apparatus 100, at least part of the core of the operating system is loaded in the main memory 111 and executed by the processor 110. The operating system of the device 100 is for example a Windows, UNIX, Linux, Android, Apple iOS and/or MAC operating system.

The operating system in particular allows the apparatus 100 to be used for data processing. For example, it manages operating equipment such as the main memory 111 and the program memory 112, the communication interface 113, and the input/output device 114, inter alia provides basic functions by employing programming interfaces of other programs, and controls the execution of programs.

The processor 110 controls the communication interface 113, which for example may be a network interface and may be designed as a network card, network module, and/or modem. The communication interface 113 is in particular designed to establish a connection between the apparatus 100 and other apparatuses, in particular via a (wireless) communication system, for example a network, and to communicate therewith. The communication interface 113 may for example receive data (via the communication system) and forward said data to the processor 110, and/or receive and transmit data from the processor 110 (via the communication system). Examples of a communication system are a local network (LAN), a wide area network (WAN), a wireless network (for example in accordance with the IEEE-802.11 standard, the Bluetooth (LE) standard and/or the NFC standard), a wired network, a mobile network, a telephone network, and/or the Internet.

Furthermore, the processor 110 can control at least one input/output device 114. The input/output device 114 is, for example, a keyboard, a mouse, a microphone, a touch-sensitive display unit, a speaker, a read device, a drive, and/or a camera. The input/output device 114 may, for example, receive user inputs and forward said inputs to the processor 110, and/or receive and output information for the user of the processor 110.

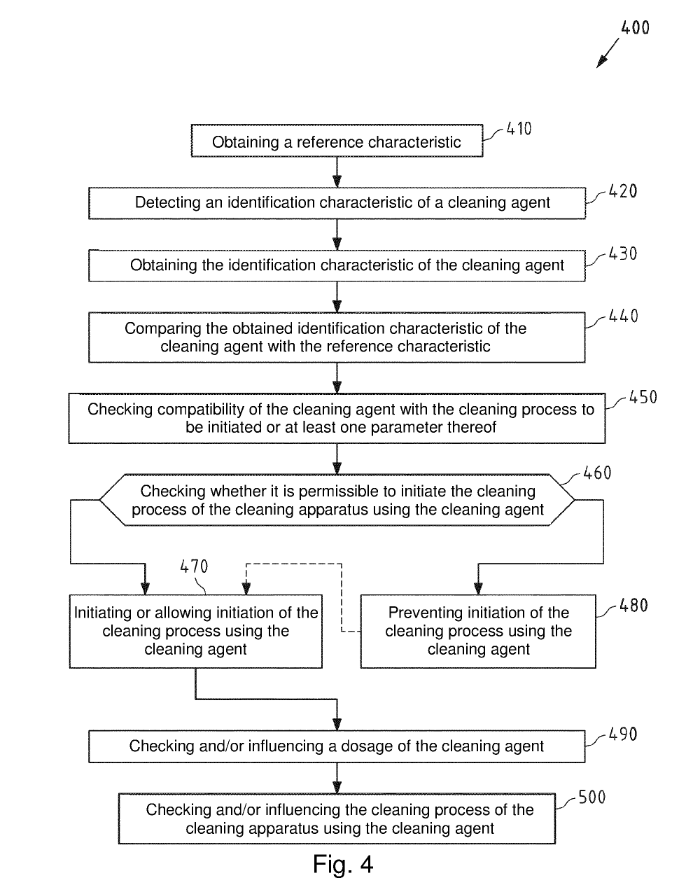

FIG. 4 is a block diagram 400 of an embodiment of a method as contemplated herein.

First, a reference characteristic is obtained (action 410). For example, one or more sets of data having one or more reference characteristics are obtained. For example, the reference characteristic is stored in a memory of the cleaning apparatus and/or of the mobile device 30. For example, the at least one reference characteristic is stored on the server 40 and is transmitted therefrom and received by the cleaning apparatus 10 and/or mobile device 30.

For example, the reference characteristic can be updated if required. For example, the server is a server of the cleaning agent manufacturer. If the cleaning agent and therefore the reference characteristic change, the server 40 can provide the cleaning apparatus 10 and/or the mobile device 30 with an updated reference characteristic.

An identification characteristic of a cleaning agent, e.g. cleaning agent 26, can be detected (action 420) by employing a sensor, e.g. the sensor 20 or 20′.

The detected identification characteristic of the cleaning agent can be obtained, for example, by employing the cleaning apparatus 10, the mobile device 30 and/or the server 40 (action 430).

The obtained identification characteristic of the cleaning agent can then be compared with the reference characteristic (action 440). The cleaning agent can be identified as a result (for example the cleaning agent A of manufacturer X) and/or the cleaning agent can be allocated to a cleaning agent group (for example a cleaning agent for purpose B or a cleaning agent of manufacturer Y or a cleaning agent of the type C).

As the cleaning agent or a cleaning agent group could be identified based on the obtained identification characteristic, it is also possible to check, if necessary, compatibility of the cleaning agent with the cleaning process to be initiated or at least one parameter thereof, for example the set temperature or the wash program (action 450).

It is then possible to check, based at least in part on the obtained identification characteristic of the cleaning agent, whether it is permissible to initiate the cleaning process of the cleaning apparatus using the cleaning agent (action 460).

If the check indicates that it is permissible to initiate the cleaning process of the cleaning apparatus using the cleaning agent, the cleaning process using the cleaning agent can be initiated or initiation of this kind can be allowed (action 470). For example, it is permissible to initiate a cleaning process if a specific cleaning agent has been identified, if a specific cleaning agent group which is to be associated with the cleaning agent has been identified, or if compatibility has been established.

If the check indicates that it is not permissible to initiate the cleaning process of the cleaning apparatus using the cleaning agent, initiation of the cleaning process using the cleaning agent can be prevented (action 480). For example, it is not permissible to initiate a cleaning process if a specific cleaning agent has not been identified, if a specific cleaning agent group which is to be associated with the cleaning agent has not been identified, or if no compatibility has been established.

Initiation of the cleaning process using the cleaning agent can be prevented only temporarily. For example, initiating or allowing initiation of the cleaning process using the cleaning agent can nonetheless take place after initiation of the cleaning process using the cleaning agent has been prevented. In this way, the user may, if necessary, nonetheless have the opportunity to initiate the cleaning process, or use a combination of cleaning agent and cleaning process which is not actually permissible.

As the cleaning agent or a cleaning agent group could be identified based on the obtained identification characteristic, dosing information for the corresponding cleaning agent can be obtained and used, for example, in order to check or influence a dosage of the cleaning agent (action 490).

The cleaning process of the cleaning apparatus using the cleaning agent can likewise be checked or influenced (action 500). By employing the cleaning agent identified on the basis of the identification characteristic or the identified cleaning agent group, parameters of the cleaning process can be checked, for example, as to whether said parameters are compatible or optimal, or compatible or optimal parameters can be set.

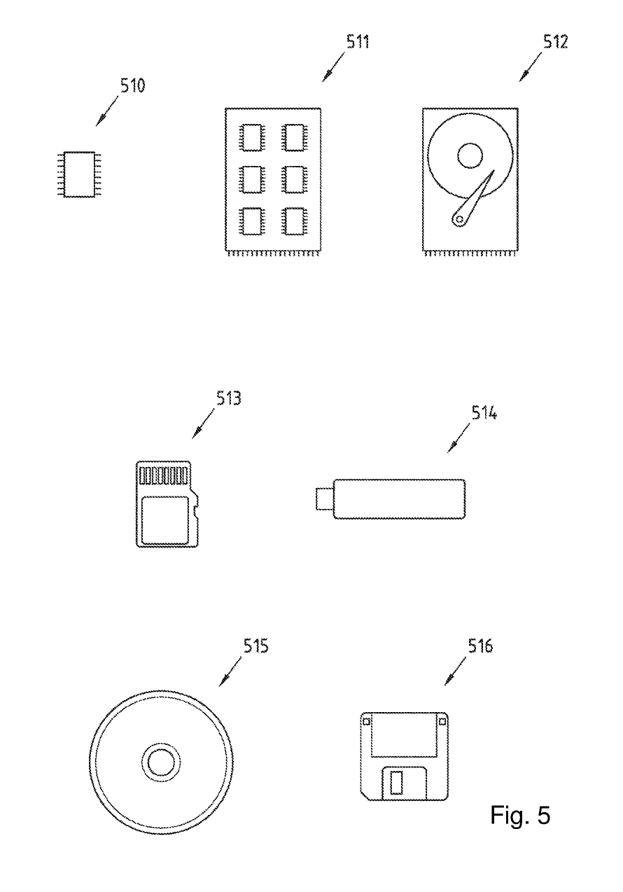

FIG. 5 lastly shows different embodiments of memory media on which an embodiment of a computer program as contemplated herein can be stored. The memory medium may be, for example, a magnetic, electrical, optical and/or different memory medium. The memory medium may for example be part of a processor (e.g. the processor 110 in FIG. 3), for example a (non-volatile or volatile) program memory of the processor, or a part thereof (such as the program memory 112 in FIG. 3). Embodiments of a memory medium are a flash memory 510, an SSD hard drive 511, a magnetic hard drive 512, a memory card 513, a memory stick 514 (e.g. a USB stick), a CD-ROM or DVD 515, or a floppy disk 516.

The exemplary embodiments of the present disclosure described in this specification and the optional features and properties mentioned in each case in this respect are also intended to be understood to be disclosed in any combination with one another. In particular, unless explicitly stated otherwise, the description of a feature included in an embodiment should not be understood in the present case such that the feature is indispensable or essential for the function of the embodiment. The sequence of method steps set out in this specification in the individual flow diagrams is not compulsory, and alternative sequences of the method steps are conceivable. The method steps can be implemented in different ways, and therefore implementation in software (by employing program instructions), hardware, or a combination of both is conceivable for implementing the method steps.

Terms used in the claims such as “include,” “comprise,” “contain” and the like do not preclude additional elements or steps. The wording “at least in part” covers both “partly” and “completely.” The wording “and/or” is intended to be understood such that both the alternative and the combination are intended to be disclosed, i.e. “A and/or B” means “(A) or (B) or (A and B).” The use of the indefinite article does not preclude a plurality. A single apparatus can carry out the functions of a plurality of units or apparatuses mentioned in the claims. Reference numerals used in the claims are not intended to be considered restrictions of the agents and steps used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A method, carried out by at least one apparatus, the method comprising:
obtaining, with the at least one apparatus, an identification characteristic of a cleaning agent,
checking, with the at least one apparatus and based at least in part on the obtained identification characteristic of the cleaning agent, whether it is permissible to initiate a cleaning process of a cleaning apparatus using the cleaning agent; and
preventing initiating the cleaning process, with the at least one apparatus, using the cleaning agent after determining that it is not permissible to initiate the cleaning process of the cleaning apparatus using the cleaning agent; and/or
initiating or allowing initiation of the cleaning process, with the at least one apparatus, using the cleaning agent after determining that it is permissible to initiate the cleaning process of the cleaning apparatus using the cleaning agent.

2. (canceled)

3. The method according to claim 1, the method further comprising:
comparing, with the at least one apparatus, the obtained identification characteristic of the cleaning agent with at least one reference characteristic.

4. The method according to claim 1, the method further comprising:
detecting, with the at least one apparatus, the identification characteristic of the cleaning agent.

5. The method according to claim 4, wherein the identification characteristic is detected by a sensor of a cleaning apparatus, a part thereof, or a dosing aid.

6. The method according to claim 1, the method further comprising:
obtaining, with the at least one apparatus, the reference characteristic.

7. The method according to claim 1, wherein the identification characteristic allows identification
of the cleaning agent and/or
of a cleaning agent group.

8. The method according to claim 1, wherein the identification characteristic is representative of at least one chemical and/or physical property of the cleaning agent.

9. The method according to claim 1, wherein the identification characteristic is representative of a spectral property and/or electrical conductivity of the cleaning agent.

10. The method according to claim 1, wherein the cleaning agent comprises one or more additives for inducing the identification characteristic.

11. The method according to claim 10, wherein the one or more additives comprise:
a chemical marker,
a dye,
a functional dye,
an odorant, and/or
a substance that modifies conductivity of the cleaning agent.

12. The method according to claim 1, the method further comprising:
initiating or allowing initiation, with the at least one apparatus, of the cleaning process using the cleaning agent after initiation of the cleaning process using the cleaning agent has been prevented.

13. The method according to claim 1, the method further comprising:
checking, with the at least one apparatus, compatibility of the cleaning agent with the cleaning process to be initiated or at least one parameter thereof, based at least in part on the obtained identification characteristic.

14. The method according to claim 1, the method further comprising:
checking and/or influencing, with the at least one apparatus, the cleaning process of the cleaning apparatus using the cleaning agent, based at least in part on the obtained identification characteristic of the cleaning agent.

15. The method according to claim 1, the method further comprising:
checking and/or influencing, with the at least one apparatus, a dosage of the cleaning agent, based at least in part on the obtained identification characteristic of the cleaning agent.

16. An apparatus that is configured for carrying out and/or controlling a method according to claim 1.

17. An apparatus according to claim 16, comprising at least one processor and at least one memory comprising computer program code, wherein the at least one memory and the computer program code are configured to carry out and/or control the method according to claim 1 using the at least one processor.

18. (canceled)

19. A computer-readable memory medium, that is a physical object, which comprises a computer program comprising program instructions that prompt the processor to execute and/or control a method according to claim 1.

20. (canceled)
